(19) United States
(12) Patent Application Publication
(10) Pub. No.: US 2014/0029729 A1
(43) Pub. Date: Jan. 30, 2014

(54) GRADIENT VACUUM FOR HIGH-FLUX X-RAY SOURCE

(71) Applicant: Agilent Technologies, Inc., Loveland, CO (US)

(72) Inventor: Damian Kucharczyk, Wroclaw (PL)

(21) Appl. No.: 13/927,790

(22) Filed: Jun. 26, 2013

(30) Foreign Application Priority Data
Jul. 26, 2012 (EP) EP12178137

(51) Int. Cl. H01J 35/10

(52) U.S. Cl. CPC H01J 35/106
USPC 378/123

(57) ABSTRACT

An X-ray tube for generating an X-ray beam, the X-ray tube comprising a rotatably mounted anode arranged and configured to generate X-rays upon exposure to an electron beam, a hollow space within the anode, a cooling unit configured for cooling the anode by fluid circulation within the hollow space, and a vacuum pump arrangement configured for generating a first vacuum within the hollow space and a second vacuum in a space surrounding the anode, wherein the second vacuum relates to a pressure value being lower than a pressure value relating to the first vacuum, wherein the vacuum pump arrangement comprises a pump arranged for forming a continuous pressure gradient between the first vacuum and the second vacuum.

### BACKGROUND

The present invention relates to an X-ray tube, an X-ray source and a method of operating an X-ray tube.

An X-ray tube is a vacuum tube that produces X-rays. X-rays are part of the electromagnetic spectrum with wavelengths shorter than ultraviolet light. X-ray tubes are used in many fields such as X-ray crystallography, medical devices, airport luggage scanners, and for industrial inspection.

An X-ray tube comprises a cathode, which emits electrons into vacuum and an anode to collect the electrons, thus establishing an electron beam. A high voltage power source is connected across cathode and anode to accelerate the electrons. Electrons from the cathode collide with the anode material so that a part of the energy generated is emitted as X-rays. The X-ray beam may then be shaped by passing an X-ray optics and subsequently a collimator. The remaining part of the energy causes the anode to be heated. The heat is removed from the anode, typically by radiative or conductive cooling and might involve the use of cooling water, flowing behind or inside the anode.

In a rotating anode tube, the anode can be rotated, for instance by electromagnetic induction from a series of stator windings outside the evacuated tube. The purpose of rotating the anode is to cause the electron beam to collide with the anode at a range of positions along a circular track instead of one stationary position, which thus spreads out the heating and allows a greater electron beam power to be used, thus generating a higher power of X-rays. However, the anode requires complex cooling to obtain high X-ray flux. Moreover, the rotation of the anode requires highly complex bearings and sealings to maintain the vacuum.

U.S. Pat. No. 8,121,258 discloses a device to deliver an X-ray beam at energies greater than 4 keV, comprising an X-ray source comprising an electron gun adapted to generate a continuous beam of electrons onto a target region of an anode for X-ray emission by the anode, wherein said anode forms a solid of revolution of a diameter between 100 and 250 millimetres, and is fixedly connected to a motor shaft so that it is driven in rotation by a rotation system, and the electron gun and the anode are arranged in a vacuum chamber, said chamber comprising an exit window to transmit an X-ray beam emitted by the anode outside of the chamber, conditioning means to condition the X-ray beam emitted through the exit window, the conditioning means comprising an X-ray optic adapted to condition the X-ray beam emitted with a two-dimensional optic effect, wherein the electron gun is designed to emit an electron beam of a power less than 400 watts, and comprises means to focus said electron beam on the target region in a substantially elongate shape defined by a small dimension and a large dimension, wherein the small dimension is comprised between 10 and 30 micrometres and the large dimension is 3 to 20 times greater than the small dimension, the rotating anode comprises an emission cooling system to evacuate, by radiation, part of the energy transmitted by the electron beam to the anode, the rotation system comprises a motor with magnetic bearings designed to set the rotating anode in rotation at a speed of more than 20,000 rpm, and the exit window is arranged so as to transmit an X-ray beam emitted by the anode so that the X-ray beam emitted towards the conditioning means is defined by a substantially point-size focal spot of dimension substantially corresponding to the small dimension of the shape of the target region.

Conventionally, the provision of proper scalings between different components of a rotating anode X-ray tube is cumbersome.

### SUMMARY

It is an object of the invention to provide an X-ray tube of the rotating anode type which has a compact design and does not suffer from cumbersome sealing. The object is solved by the independent claims. Further embodiments are shown by the dependent claims.

According to an exemplary embodiment of the present invention, an X-ray tube for generating an X-ray beam is provided, the X-ray tube comprising a rotatably mounted anode (particularly a rotating anode) arranged and configured to generate X-rays upon exposure to an electron beam (which may be generated by emitting electrons from an electron emitter and by accelerating the emitted electrons by applying a high voltage between emitter and anode), a hollow space (such as a recess) within the anode, a cooling unit configured for cooling the anode (which is heated by the electron beam) by fluid circulation within the hollow space, and a vacuum pump arrangement (i.e. one or more interconnected vacuum pumps) configured for generating a first vacuum (such as a first negative pressure, i.e. below atmospheric pressure) within the hollow space and a second vacuum (such as a second negative pressure) in a space surrounding the anode, wherein the second vacuum relates to a pressure value being lower than a pressure value relating to the first vacuum, wherein the vacuum pump arrangement comprises a pump (which may be denoted as a gradient pump) arranged for forming a continuous pressure gradient (particularly along a seal-free flow path) between the first vacuum and the second vacuum.

According to another exemplary embodiment, an X-ray source is provided which comprises an X-ray tube having the above mentioned features, an X-ray optic (which may comprise one or more mirrors) for collecting and focussing X-rays generated in the X-ray tube, and optionally an X-ray beam conditioner (such as a collimator) for conditioning the X-rays after collecting and focussing them by the X-ray optic.

According to yet another exemplary embodiment, a method of operating an X-ray tube for generating an X-ray beam is provided, wherein the method comprises exposing a rotating anode to an electron beam to thereby generate X-rays, cooling the anode by fluid circulation within a hollow space within the rotating anode, and operating a pump (which may be denoted as a gradient pump, for instance a molecular drag vacuum pump) to form a continuous pressure gradient between a first vacuum, provided (or generated) by another pump (such as a low vacuum pump like a diaphragm pump), and a second vacuum so that the first vacuum is present within the hollow space and the second vacuum is generated by the gradient pump (using the or based on the first vacuum) in a space surrounding the anode, wherein the second vacuum relates to a pressure value being lower than a pressure value relating to the first vacuum.

In the context of this application, the term “continuous pressure gradient between first vacuum and second vacuum” may particularly denote that the pressure distribution along a flow path along which the pumped medium (such as gas) is pumped by the gradient pump is continuous and does not have abrupt or discontinuous pressure steps or discontinuities. This can be ensured by the use of a vacuum pump which supports a pressure gradient between the first vacuum and the second vacuum, without implementing seals in the flow path. For instance, a vacuum pump having a rotor attached to an anode to rotate the anode may be used.

According to an exemplary embodiment of the invention, an X-ray tube is provided which has a vacuum pump (such as a molecular drag vacuum pump) maintaining a continuous pressure gradient within a pump chamber operating between a first (lower) vacuum and a second (higher) vacuum. The lower vacuum may be generated within a hollow space of a rotating anode so that a cooling fluid may still be conducted through the hollow space of the rotating anode without the danger of evaporation of the cooling fluid. Without the necessity of providing any seals along its vacuum path (and therefore between the hollow space of the anode and the space surrounding the anode), the gradient pump provides at its higher vacuum end the higher second vacuum in a direct surrounding of the rotating anode. Cumbersome seals can be omitted in view of the performance of the gradient pump operating between the first vacuum and the second vacuum. Such a gradient pump having a rotor and a stator may have the rotor integrally formed with the rotating anode, thereby obtained a compact constitution. With the disclosed design it is possible to efficiently cool the rotating anode by the cooling unit, which is partially integrated within the rotating anode, and at the same time to generate a proper vacuum outside thereof. A strict separation between the first vacuum and the second vacuum is dispensable due to its generation by a gradient pump so that seals can be omitted. A simple construction can be combined with a high-flux of the X-ray beam in view of the efficiently cooled rotating anode and the proper vacuum in its surrounding.

Therefore, by implementing a gradient pump such as a molecular drag vacuum pump within a chamber of an X-ray tube, seals can be omitted. Hence, a basically maintenance-free X-ray tube is obtained. No discontinuous or stepwise change of the pressure occurs between the first vacuum and the second vacuum. In contrast to this, a pressure gradient which continuously transits from the first vacuum to the second vacuum.

Next, further exemplary embodiments of the X-ray tube will be explained. However, these embodiments also apply to the X-ray source and the method of operating an X-ray tube.

In an embodiment, the pump is a molecular drag vacuum pump arranged for operating between the first vacuum and the second vacuum. In the context of this application, the term “molecular drag vacuum pump” may particularly denote a vacuum pump which has an empty space or volume between a rotor and a stator, wherein rotating the rotor against the stator will evacuate a medium to be pumped (such as a gas) propagating along a path (for instance a helical path) between rotor and stator. Thus, such a molecular drag vacuum pump works between a higher pressure (or starting pressure), which is nevertheless a negative pressure (of for instance 20 mbar or less), and a lower pressure (or final pressure). Along the working path of a molecular drag vacuum pump, the pressure value may be gradually reduced so that there may be a gradient vacuum along the path. In the context of this application, the term “operating a molecular drag vacuum pump between a first vacuum and a second vacuum” may particularly denote that the molecular drag vacuum pump uses a starting vacuum (which may be provided by another pump) and then generates a better or lower vacuum. Thus, the skilled person will clearly understand that the molecular drag pump does not create the first vacuum. The first vacuum is initially created by the low vacuum pump as an initial pumping help enabling the molecular drag pump to start pumping. The low vacuum pump thus maintains the first vacuum and the molecular drag pump creates a pressure gradient on top of that first vacuum in order to make the second vacuum which has a pressure lower than the first vacuum.

As an alternative to a molecular drag vacuum pump, it is for instance possible to use a turbo molecular pump as gradient pump.

In an embodiment, the pressure value relating to the first vacuum is in a range between about 10⁻³ mbar and about 20 mbar. Thus, a relatively simple vacuum is sufficient as the first vacuum which also prevents cooling fluid of the cooling unit from undesired evaporation. For instance, an oil may be used which does not evaporate until 10⁻⁴ mbar. In such an example, a minimum possible pressure for the first vacuum may be 10⁻³ mbar.

In an embodiment, the pressure value relating to the second vacuum is in a range between about 10⁻⁴ mbar and about 10⁻⁶ mbar. Such a medium vacuum is appropriate for a milieu in which X-rays are generated by bombarding the rotating anode, as a target, with an electron beam.

In an embodiment, the rotatably mounted anode is fixedly coupled to a rotor of the molecular drag vacuum pump so as to be rotatable together with the rotor. In other words, the rotating anode and the rotor of the molecular drag vacuum pump may be integrally formed. This results in a compact design.

In an embodiment, the cooling unit comprises a cooling fluid pump configured for cyclically pumping a cooling fluid through the hollow space. Such a cooling fluid pump may be flanged or attached to the housing of the X-ray tube or may be located therein. This also contributes to a compact design.

In an embodiment, the cooling fluid pump comprises an oil pump or a liquid metal pump. Oil or liquid metals have the advantage of not being prone to evaporation in the presence of a pressure such as 10⁻³ mbar to 20 mbar as generated as the first vacuum. Therefore, the vacuum generation and the pumping of the cooling fluid can take place simultaneously.

In an embodiment, the cooling unit comprises a capillary extending into the hollow space so that the cooling fluid is pumped through the capillary, via an open end of the capillary into the hollow space, and from the hollow space back (into the cooling fluid pump) via a gap between an outer surface of the capillary and a rotor of the molecular drag vacuum pump. Such a capillary may be mounted as a static, i.e. not-rotating, member which extends into the rotating anode and serves as a guiding structure for the cooling fluid.

In an embodiment, the X-ray tube comprises a rotatably mounted cooling fluid distributor arranged at the open end of the capillary for distributing the cooling fluid within the gap by a centrifugal force and by pressure applied by the cooling fluid pump. Such a cooling fluid distributor may act as some kind of ventilator which has the function to apply a centrifugal force to the cooling fluid exiting an end of the capillary. The pressure with which the cooling fluid is guided through the capillary also contributes to the distribution of the cooling fluid.

In an embodiment, the capillary is fixedly mounted so as to remain stationary, particularly upon rotation of the anode, the rotor and the cooling fluid distributor. Thus, the number of rotating parts may be kept small.

In an embodiment, the cooling unit comprises a heat exchanger, particularly a water heat exchanger, configured for removing heat from the circulating cooling fluid. During the circulation, the cooling fluid will be heated by heat of the rotating anode generated when the electron beam hits the rotating anode for X-ray generation. Hence, the cooling fluid propagates with a relatively low temperature towards the rotating anode, is heated there, and propagates back into the cooling fluid pump where it can be cooled again by a heat exchanger. Therefore, a continuous operation of the X-ray tube is made possible.

In an embodiment, the molecular drag vacuum pump comprises a rotatably mounted rotor and a fixedly mounted stator enclosing a seal-free flow path (for instance a helical flow path) for the medium to be evacuated. It serves to evacuate gas molecules in the space surrounding the anode to thereby generate the second vacuum. More precisely, the rotor may be sandwiched between two parts of the stator. The medium to be evacuated, i.e. a gas, may then be forced along the seal-free flow path for generating the vacuum.

In an embodiment, the X-ray tube comprises comprising a flow reducing structure arranged between the rotor and the anode (particularly forming a locally narrowed neck in the flow path) for reducing pressure exchange between the space surrounding the anode and a space between stator and rotor. Such a flow reducing structure may be any kind of flow impedance which has the effect that it retards the pressure equilibration between the two spaces separated by the flow reducing structure. In an embodiment, the flow reducing structure may be a neck in a housing of the X-ray tube. Therefore, it can be suppressed that the vacuum in the space surrounding the rotating anode is deteriorated by a pressure exchange between the low vacuum and the high vacuum end of the gradient pump.

In an embodiment, the molecular drag vacuum pump is configured to evacuate, through the flow reducing structure, also gas molecules around the rotatable anode. Since the coupling through the flow reducing structure is only weakened but not rendered impossible, the molecular drag vacuum pump also contributes to pumping the space directly surrounding the rotating anode.

In an embodiment, the flow reducing structure is arranged so that a third vacuum (such as a third negative pressure) or vacuum range (such as a negative pressure range) within the space between stator and rotor relates to one or more pressure values—particularly a pressure gradient—being larger than or equal to a pressure value relating to the second vacuum. This may be caused or supported by additionally pumping the second vacuum through another aperture (or other flow reducing structure) by a further pump generating the below-described fourth vacuum (present in the electron beam emitter space), wherein the fourth vacuum is an even higher vacuum than the second vacuum. With the pumping effect of the fourth vacuum, the second vacuum may have a pressure equal to or smaller than the third vacuum. The vacuum will then be continuously improved from the interior of the rotating anode via a gap between rotor and stator of the molecular drag vacuum pump, through the flow reducing structure towards a space surrounding the rotating anode. In other words, the vacuum in the space surrounding the rotating anode will be not worse than the vacuum in the space separated from the space surrounding the rotating anode by the flow reducing structure.

In an embodiment, the vacuum pump arrangement comprises a low vacuum pump (such as a rotary vane pump or a diaphragm pump) for generating the first vacuum. However, any other kinds of low vacuum pumps are possible as well. Such low vacuum pumps may be arranged internally or externally of a housing of the X-ray tube.

In an embodiment, the X-ray tube comprises an electron beam generator chamber being at the above-mentioned fourth vacuum (such as a fourth negative pressure) and having an electron beam generator configured for generating the electron beam, wherein the fourth vacuum—generated by a further pump—relates to a pressure value being lower the pressure value relating to the second vacuum. Such an electron beam generator or electron beam emitter is configured for generating the electron beam to be directed towards the anode of the X-ray tube for generating the X-ray beam. The electron beam emitter comprises an electrically conductive element such as a filament made of material capable of emission of electrons and configured to be supplied with electric energy for emitting the electron beam. Hence, for generating the electron beam, an electrically conductive structure such as a metallic filament (for instance from tungsten) is heated by an electric current applied thereto. Consequently, an electron beam is emitted from such an electron beam emitter structure. The electron beam is then accelerated towards the rotating anode to thereby generate the X-ray beam. Within the space at which the electron emission takes place, a very high vacuum is advantageous. The vacuum in the electron beam generator chamber can be the best vacuum within the entire X-ray tube.

In an embodiment, the pressure value relating to the fourth vacuum is in a range between about 10⁻⁶ mbar and about 10⁻¹⁰ mbar. For instance, the fourth vacuum may be at least one order of magnitude better than the second vacuum.

In an embodiment, the space surrounding the anode is seal-free, particularly window-free, connected to the electron beam generator chamber. Advantageously, any window between electron beam generator chamber and the space surrounding the anode may be omitted. These spaces may be directly connected to one another in terms of fluid (particularly gas) communication. By omitting the window between the space surrounding the anode and the electron beam generator chamber, a high intensity electron beam can be generated and directed towards the rotating anode.

In an embodiment, the X-ray tube comprises a further flow reducing structure arranged between the space surrounding the anode and the electron beam generator chamber (particularly forming a further locally narrowed neck in the flow path) for reducing pressure exchange between the space surrounding the anode and the electron beam generator chamber. Particularly, the electron beam generator is arranged for guiding the electron beam from the electron beam generator chamber to the anode via the further flow reducing structure. Such a further flow reducing structure may be a flow impedance and may suppress equilibration of pressure between the electron beam generator chamber and the space surrounding the rotating anode. This further flow reducing structure may substitute a window between the electron beam generator chamber and the rotating anode.

In an embodiment, the vacuum pump arrangement comprises a high vacuum pump, particularly a turbo molecular vacuum pump, for generating the fourth vacuum. This high vacuum pump may be arranged externally of a housing of the X-ray tube accommodating the rotating anode and the electron beam generator.

In an embodiment, the high vacuum pump is configured for operating between the fourth vacuum and another vacuum, particularly the first vacuum, provided by the low vacuum pump. For generating such a high vacuum, a proper starting vacuum will be necessary. By synergetically using the first vacuum provided by the low vacuum pump, the number of required pumps for the X-ray tube may be kept small, rendering the X-ray tube compact.

For instance, all spaces within the housing of the X-ray tube being at different vacuum values may be connected to one another in a seal-free manner. The fourth vacuum may relate to the smallest pressure value, followed by the second vacuum, the third vacuum and the first vacuum. The different pressure values may be maintained by the arrangement of the individual vacuum pumps of the vacuum pump arrangement and by flow reducing structures or flow impedances arranged along the spaces.

In an embodiment, the X-ray tube comprises a tube housing accommodating at least the anode and the gradient pump. Such a tube housing may define the external boundary of the X-ray tube.

In an embodiment, the tube housing has a window being at least partially transparent for X-rays and being arranged so that the X-rays are capable of propagating from the anode, via the window into an optic housing having X-ray optics for collecting and focussing the X-rays. The optic housing may be attachable to the tube housing. Such a window may for instance be made of Beryllium or any other material being not prone to absorb X-rays to a significant extent.

In an embodiment, the tube housing has a first section accommodating the anode and has a second section accommodating the gradient pump. The first section may be made of a material being strongly attenuating or basically intransparent for X-rays, for example steel. The second section may be made of another material than the first section, particularly a light-weight metal such as Aluminum. The latter material is not necessarily a material being strongly attenuating for X-rays. Conventionally, the entire tube housing of an X-ray tube has to be made of a material which is intransparent for X-rays for safety reasons. This is however dispensable by the X-ray tube according to the described embodiment, because of the narrow neck serving as the further flow reducing structure. In view of the narrow neck, the first section almost completely circumferentially encloses the anode so that X-rays can be basically constricted within the first section. Hence, the freedom of choice regarding the material of the second section is advantageously increased so that it can for instance be made of a light-weight material such as aluminium.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates an X-ray tube with an attached optic housing according to an exemplary embodiment of the invention.

FIG. 2 is a cross-section of an X-ray source having an X-ray tube according to an exemplary embodiment of the invention.

FIG. 3 is a three-dimensional view of the X-ray source according to FIG. 2.

FIG. 4 is a cross-sectional view of the X-ray tube of the X-ray source of FIG. 2.

FIG. 5 is another cross-sectional view of a part of the X-ray source of FIG. 2.

The illustration in the drawing is schematically.

### DETAILED DESCRIPTION

In the following, some considerations of the present inventors with regard to the design of X-ray tubes will be explained, based on which a gradient vacuum system for a high-flux X-ray source according to an exemplary embodiment of the invention has been developed.

An exemplary embodiment of the invention relates to the design of an ultra compact high intensity X-ray source. Designed for applications in the Field of X-ray diffraction and X-ray crystallography it also has applications in other fields requiring a high intensity X-ray source. The general method of operation of embodiments of the invention is typical of X-ray sources in the field. By the application of a voltage to an emitter, a focused beam of electrons is generated in a vacuum and accelerated under a potential high voltage towards a metal target anode. When the electron beam hits the anode, X-rays are generated plus heat. The X-rays are used for one of the above-mentioned or other applications, and the heat is dissipated through cooling of the target anode.

Existing devices of the rotating anode X-ray generator type have the disadvantages of being large, requiring significant routine service and non-routine maintenance, having significant component parts prone to failure and with high cost of ownership. Embodiments of the invention achieve a high amount of X-ray brilliance on the sample of study with great efficiency. The following lists certain approaches, which can be used independently or in combination:

(1) Increase of the power applied to the electron generating emitter. Typical power loadings are up to 5 kW, but much higher powers of up to 20 kW or more are known. An issue is that the anode can easily be destroyed from lack of an effective cooling mechanism.

(2) Increase of the electron power density on the anode target using a smaller, more focused beam of electrons. For instance, 1 kW of power is applied to the filament/emitter generating a beam of electrons which is directed towards the anode. The beam of electrons is focused down from typically over 1 mm in diameter to a micro-focus electron beam of typically 0.1 mm to 0.05 mm. This means that the same number of total electrons hit the anode target in a smaller spot area. The ratio of area of the micro-focus spot to its surrounding area allows greater heat dissipation via conduction. An issue is how small it is possible to focus the electron beam and how high the power loading can be. Again this relies on effective cooling to prevent irrevocable and fatal damage to the anode target.

(3) Rotation of the anode target at increasing speed such that the point where the electron beam hits the anode is rapidly changing, thus spreading the heat loading on the anode. Typically, rotating anodes of this type are rotated at up to 10,000 rpm, inertial drag and stability limiting higher speeds. The need for rotation and vacuum leads to the use of ferromagnetic fluid seals (or ferrofluidic seals) and vacuum feed throughs, resulting in a poorer vacuum and ultimately a reduced lifetime of the emitter and anode. Typically, as the power loading increases the anode to be rotated increases in size to allow for the cooling.

(4) Selection and appropriate positioning of an X-ray optic. Typically, placing a matched X-ray optic close to the source of X-rays generated from the anode is beneficial as it provides more efficient X-ray capture. In addition since X-ray radiation intensity falls off in air with increasing distance, then a shorter X-ray path from the source to the sample is beneficial. This can be partially mitigated by use of a vacuum or helium X-ray beam path. The large size of the source construction typically places the optic further away from the anode resulting in reduced X-ray brilliance performance.

In view of the foregoing, exemplary embodiments of the invention involve the following aspects:
Provision of a high vacuum environment around the anode, the electron beam and the X-ray path, whilst generating X-rays and achieving a very compact design, thus increasing the achieved X-ray brilliance on the sample of study.
Achieving a greatly simplified and very compact X-ray source leading to a device of greatly reduced maintenance, easy servicing and high performance in terms of higher brilliance X-ray beam on the sample.
Faster rotation of the anode is allowed with the added advantage of the vacuum pump providing, or more precisely substituting, a vacuum seal. Typically, the speed of rotation is limited by the physical size and design of the anode target.
   As the physical size of the anode increases so does the inertial mass and instability results in the rotating anode leading to damage and also instability in the X-ray beam being generated. In an embodiment of the invention, the size of the anode is required to be small allowing for higher rotation speeds. This small size is achievable due to the disclosed design for cooling the back of the anode, the faster rotation, and the design of a swinging electron beam to further spread the heat load.

Hence, embodiments of the invention provide a combination of the following:
Higher performance in terms of a higher X-ray brilliance on the sample
A more stable X-ray beam
Better anode cooling
Greatly reduced maintenance/service and support
A much more compact X-ray source
Improved high vacuum/vacuum system leading to compactness and higher performance and reliability
Software control and alignment of the electron beam on the anode
Variable X-ray beam size on the sample definable via software control
Dynamic movement of the electron beam such that it is caused to hit the anode over a range of positions, spreading the heat load

An exemplary embodiment of the invention is designed to allow a greater power density of the electron beam to be impinged on an anode surface without immediate total destruction of the anode material and to thereby generate usable X-rays of a greater brilliance for collimation and conditioning them. The shaped X-ray beam can then be directed to and used for a sample to be studied/exposed to the X-rays. An embodiment of the invention is capable to provide X-ray intensity in the range between 0.75 and 2 times of that currently obtainable from the highest intensity home laboratory X-ray sources used in the field of X-ray diffraction and/or crystallography. The method of electron beam swing and optical projection provides for an electronically and thus software controllable X-ray beam size at the position of the sample to be studied. In certain fields of application, the ability to match the X-ray beam size to the size of the sample is desirable. A small weakly diffracting sample benefits from a smaller, more highly focused and higher intensity X-ray beam, whereas a larger sample may benefit from a larger diameter X-ray beam of lower intensity. An apparatus according to an embodiment of the invention is significantly more compact and much more serviceable and lower maintenance than other X-ray sources of the type whilst providing equivalent or greater X-ray intensity.

Greater intensity X-ray beams are desirable in the field of crystallography for obtaining higher resolution three-dimensional crystallographic structural data from the sample. In an embodiment, the anode is mounted atop the rotor drive shaft of a molecular drag vacuum pump which serves to rotate the anode at an operating speed of at least 25,000 rpm, whilst also providing a vacuum seal to the device and maintaining an area of lower vacuum pressure as part of a gradient vacuum environment. The heat generated on the anode is removed from the back of the anode by means of a media cooling path which comprises a hollow anode of open construction with the drive shaft of the molecular drag vacuum pump and a heat exchange cooling media reservoir. The cooling media, for instance vacuum-pump oil, is circulated from the anode to the heat exchanger cooling media reservoir by means of a pump.

An embodiment of the invention is based on the principle of a gradient vacuum. This approach provides the required high vacuum environment for the electron beam and X-ray generation whilst removing the need for vacuum feed-through and ferromagnetic fluid vacuum seals. In traditional rotating anode systems the anode is rotated by a motor which is outside of the vacuum chamber and is cooled by water which also has to enter the chamber. Thus, rotating seals (for instance ferromagnetic fluid) are required. In an embodiment of the invention, the rotation and cooling are both achieved inside the vacuum chamber and therefore rotating seals and water pipe rotating feed-throughs are not required. In this gradient vacuum approach, two or more areas are necessarily connected whilst maintained at different vacuum pressures. This can also be one area in which different regions are maintained at different vacuum pressures. The intervening area between the areas of higher vacuum and lower vacuum will thus provide a vacuum gradient between higher and lower vacuum. In an embodiment, at least three interconnected areas/chambers are present. These areas are dynamically pumped to maintain their pressures. The first area is maintained at low vacuum, about 10 mbar, using a low vacuum pump (such as an oil-free diaphragm pump). This area contains the cooling media for the anode and is situated behind the molecular drag pump which requires low vacuum at the outlet end. The liquid cooling media is usable under this low vacuum pressure but would not be usable under high vacuum (where it could evaporate into vapour). The low vacuum space extends to all places where the liquid cooling media circulates (thus up the centre of the pump rotor and inside the anode disc). The molecular drag pump creates a vacuum of about 10⁻⁵ to 10⁻⁶ mbar at the inlet end. At this end of the molecular drag pump the anode is mounted on the pump rotor. The vacuum space around the rotating anode is partially closed and thus comprises a second area. It is partially separated from the molecular drag pump rotor but a slit is allowed around the shaft to allow pumping out of the volume of air (but note that this is not a seal around the rotor shaft, which would inhibit free rotation). A third area is maintained at high vacuum, for instance 10⁻⁷ bar, using a turbo-molecular vacuum pump. The emitter, electron path and electrostatic/electromagnetic focusing optics for the electron beam are contained in this high vacuum area. This ensures the vacuum cleanliness required to get efficient electron beam creation from the emitter and long life-time for the emitter parts. The electron beam shall pass from the high vacuum area into the medium vacuum area in order to impinge onto the anode, to create X-rays, and thus a small aperture is created to join the two areas. The aperture is sized such that the electron beam may efficiently transfer and yet the pressure differential is maintained between the two areas. The gradient vacuum approach provides the optimum vacuum regimes for the various components (which is high vacuum for the emitter and low vacuum for the cooling liquid) with the rotating anode sitting in intermediate vacuum in between. The partial separation of vacuum spaces isolates the sensitive emitter from pollution coming from the molecular drag pump bearings and the cooling liquid molecules diffusing from the low vacuum space.

Pollution of the emitter would reduce its efficiency and shorten its lifetime. The additional benefit of the dividing of the vacuum spaces is for safety protection of the assembly. In the case that one pump should fail or be shut down due to high voltage discharge then the division of the vacuum spaces will limit the rate at which they can change their pressure, thus giving time for the system to shut down (for instance rising to atmospheric pressure) in a more controlled manner.

Referring to the following figures, implementations of the described system will be explained:

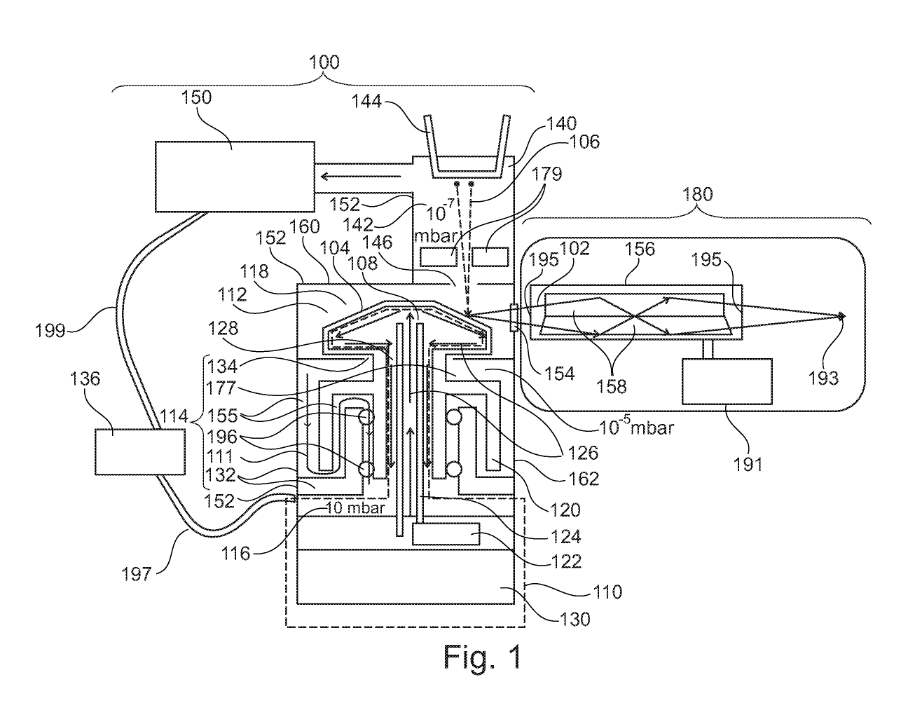

FIG. 1 illustrates, in a schematic view, an arrangement of an X-ray tube 100 for generating an X-ray beam 102 as well as of an attached X-ray optic 180 for beam shaping of the generated X-ray beam 102. The arrangement shown in FIG. 1 constitutes an X-ray source and can optionally be combined with a separate collimator structure (not shown in FIG. 1).

The X-ray tube 100 comprises a rotating anode 104 which is arranged and configured to generate the X-ray beam 102 when being exposed to or hit by an electron beam 106. An electron emitter 144 such as a metal filament to which a current is applied and which may be made, for instance, of tungsten, emits the electron beam 106 which is guided through an electrostatic and/or electromagnetic focusing optics 179 towards the anode 104. The electrostatic and/or electromagnetic focusing optics 179 is capable of manipulating properties of the electron beam 106 such as a position at which it impinges onto an exterior surface of the rotating anode 104. As known by those skilled in the art, bombarding the surface of the rotating anode 104 (which may for instance be made from copper) with the electron beam 106 will directly result in the generation of the X-ray beam 102. A high voltage is applied between the electron emitter 144 and the anode 104 to accelerate the electron beam 106 propagating therebetween.

The generated X-ray beam 102 may then be guided through an X-ray optics housing 156 of the X-ray optic 180 which may include X-ray reflection mirrors or the like. A low vacuum pump 191 generates a low vacuum within the X-ray optics housing 156 through which the X-ray beam 102 propagates. The X-ray optic 180 serves for X-ray focusing and is attached as a separate member to the X-ray tube 100.

At a sample position 193, the monochromatic X-ray beam 102 may then be brought in interaction with the sample such as a crystal or a powder. Downstream of the sample, an X-ray detector (not shown) for detecting the scattered X-rays may be provided. At the entrance and at the exit of the X-ray optic housing 156, Kaplan windows 195 are foreseen which are transparent for X-rays. As an alternative to Kapton, windows 195 may be also made of beryllium or any other material having a high transparency to X-rays.

Tube housing 152 of the X-ray tube 100 has a window 154 which is transparent for the X-ray beam 102 and which is arranged so that the X-ray beam 102 is capable of propagating from the anode 104 through the window 154 into the optic housing 156 and from there towards X-ray mirrors 158.

As can be taken from FIG. 1, a recess or hollow space 108 is formed within the rotating anode 104. Furthermore, a cooling unit 110 cools the rotating anode 104 by oil circulation within the hollow space 108. Furthermore, a vacuum pump arrangement formed of a plurality of vacuum pumps (which will be described below in more detail) is provided in the X-ray tube 100 and is configured for generating a first vacuum 116 within and below the hollow space 108. This vacuum can for instance be 1 mbar or 10 mbar. The vacuum pump arrangement is further configured for generating a second vacuum 118 in a space 112 which externally surrounds an outer surface of the rotating anode 104. The second vacuum 118 may for instance be 10⁻⁵ mbar. Hence, the second vacuum 118 is a higher or better vacuum than the first vacuum 116. As a part of the vacuum pump arrangement, a molecular drag vacuum pump 114 is provided which is integrated or located entirely within a tube housing 152 of the X-ray tube 100. The molecular drag vacuum pump 114 operates between a low vacuum, i.e. first vacuum 116, and a higher vacuum, i.e. the second vacuum 118.

As can furthermore be taken from FIG. 1, the rotatably mounted anode 104 is rigidly connected to a rotor 120 of the molecular drag vacuum pump 114. In other words, the rotating anode 104 rotates always together with the rigidly coupled rotor 120. A stator 132 of the molecular drag vacuum pump 114 always remains stationary or at a fixed position and orientation.

The cooling unit 110 comprises an oil pump 122 configured for pumping oil 126 through the hollow space 108. The oil 126 propagates without any oil sealing in the low vacuum regime 116. The cooling unit 110 furthermore has a static, i.e. not rotating, capillary 124 which extends into the hollow space 108 so that the oil 126 is pumped through the capillary 124, via an open end of the capillary 124 into the hollow space 108 for heat exchange with the rotating anode 104 (on which the electron beam 106 impinges), and from the hollow space 108 back via a gap 128 between an outer surface of the capillary 124 and the rotor 120 of the molecular drag vacuum pump 114. The capillary 124 is fixedly mounted so as to remain stationary upon rotation of the anode 104 and the rotor 120. The capillary 124 can also be denoted as a stationary oil capillary pipe. Furthermore, the cooling unit 110 comprises a water heat exchanger 130 configured for removing heat from the circulating oil 126. Thus, the oil is cooled with the heat exchanger 130 which is supplied with water via an external water supply.

Coming back to the molecular drag vacuum pump 114, the latter comprises the rotatably mounted rotor 120 and the fixedly mounted stator 132 which are spaced from one another to thereby enclose a seal-free flow path 111. In other words, part of the rotor 120 is sandwiched between an inner stator portion and an outer stator portion (constituted in this embodiment by a part of the tube housing 152). To evacuate gas molecules in the space 112 surrounding the anode 104 to thereby generate the second vacuum 118, these gas molecules move along this flow path 111. More precisely, they move along the bent flow path between the pressure 10⁻⁵ mbar and the pressure 10 mbar shown in FIG. 1. No seals are required along this flow path 111 so that the construction of the X-ray tube 100 is simple and basically maintenance-free. The flow impedance by the narrow flow path 111 is sufficient to keep the low vacuum of 10 mbar separated from the higher vacuum of 10⁻⁵ mbar. In other words, a pressure gradient will be maintained between the positions at which the pressure values of 10 mbar and 10⁻⁵ mbar are indicated in FIG. 1.

A locally narrowed neck 134 is provided as a constriction of the tube housing 152 in a flow path between the rotor 120 and the rotating anode 104. The neck 134 serves as a flow reducing structure or flow impedance and reduces or suppresses a free pressure exchange between the space 112 surrounding the anode 104 and a space 155 between stator 132 and rotor 120. Through the narrow neck 134, the impact of the molecular drag vacuum pump 114 is still operative so that the latter evacuates also gas molecules around the rotatable anode 112. The narrow neck 134 is arranged so that a third vacuum range 177 within the space 155 between stator 132 and rotor 120 involves pressure values (more precisely a continuous pressure transition or pressure gradient) so that the space 112 contains a vacuum having a pressure at least as low as the pressure of the third vacuum 177. The neck 134 is a slit around a shaft of the rotor 120 which divides the vacuum.

A low vacuum pump 136, such as a rotary vane pump, generates the first vacuum 116, as indicated by tubing 197. The low vacuum pump 136 provides, via another tubing 199 also the low pressure at a low pressure side of a turbo molecular vacuum pump 150. The turbo molecular vacuum pump 150 generates a fourth vacuum, i.e. a high vacuum 142, of for instance 10⁻⁷ mbar in the electron beam generator chamber 140 along which the electron beam 106 propagates directly after its emission.

As can be taken from FIG. 1, also the space 112 surrounding the anode 104 is connected without a window to the electron beam generator chamber 140. In other words, no seal has to be provided between the space 112 and the electron beam generator chamber 140. Also this fluidic interface is formed by a further flow reducing structure 146 which is a constricted neck arranged between the space 112 surrounding the anode 104 and the electron beam generator chamber 140. This locally narrowed neck in the flow path is configured for reducing pressure exchange between the space 112 surrounding the anode 104 and the electron beam generator chamber 140. By taking this measure, a seal-free propagation of the electron beam 106 from the electron beam generator chamber 140 into the space 112 is possible, allowing for obtaining a high-flux. The narrow neck 146 can be denoted as an aperture which divides vacuum, wherein the electron beam 106 may pass therethrough. In view of the narrow neck 146, the turbo molecular pump 150 also helps to pump the second vacuum 118 in the space 112 to a lower pressure than that of the third vacuum 177 in the space 155.

As can be taken from FIG. 1, the tube housing 152 has a first section 160 which accommodates the anode 104 and which is made of steel. Steel strongly attenuates or absorbs X-rays so as to protect an exterior of the X-ray tube 100 against X-rays. In contrast to this, the second section 162, in view of the design of the X-ray tube 100 and particularly the provision of the narrow necks 146 and 134, can be made from a light-weight material such as Aluminium which does not necessarily need to have pronounced X-ray absorbing properties. Therefore, the X-ray tube 100 can be formed with low weight.

It should be said that the molecular drag vacuum pump 114 can alternatively be, for example, a variant of a turbo-molecular pump or any other pump that one skilled in the art would consider for providing the required vacuum gradient.

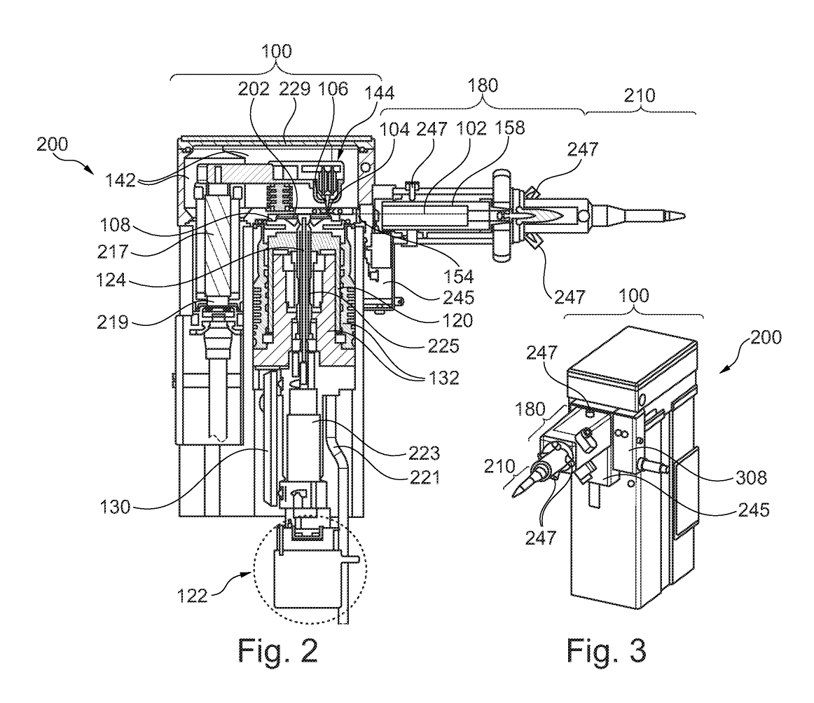

FIG. 2 shows a cross-sectional view and FIG. 3 shows a three-dimensional view of an X-ray source 200 according to an exemplary embodiment of the invention.

The X-ray source 200 has an X-ray tube 100 basically having the properties as described referring to FIG. 1. Furthermore, an X-ray optic 180 for collecting and focusing the X-ray beam 102 generated in the X-ray tube 100 is attached to the X-ray tube 100. Beyond this, an X-ray beam conditioner 210 or collimator is provided for conditioning the X-ray beam 102 after collecting and focusing it by the X-ray optic 180.

A safety shutter 308 and a fast shutter 245 are shown as well. Furthermore, adjustment screws 247 are shown by which the X-ray optic 180 can be adjusted relative to the X-ray tube 100, and the X-ray beam conditioner 210 can be adjusted relative to the X-ray optic 180. Particularly, adjustable mirror 158 of the X-ray optic 180 may be aligned by actuating the adjustment screws 247.

In addition to the components already shown in FIG. 1, the X-ray tube 100 has a rotatably mounted oil distributor 202 arranged at the open end of the capillary 124 for distributing the oil 126 within the gap 128 by a centrifugal force and by pressure applied by the oil pump 122. A high voltage vacuum isolator is denoted with reference numeral 217. Furthermore, a high voltage circuit 219 is shown. Also, a low vacuum pipe 221 and an oil tank 223 with a space for oil degassing is shown. Within the low vacuum pipe 221, the low vacuum is present (i.e. the first vacuum 116). A rotor shaft 225 with oil supply pipe inside is shown as well. Emitter 144 is removable, as well as a removable cover 229. Also, magnet-driven, positive displacement oil pump 122 is shown in FIG. 2,

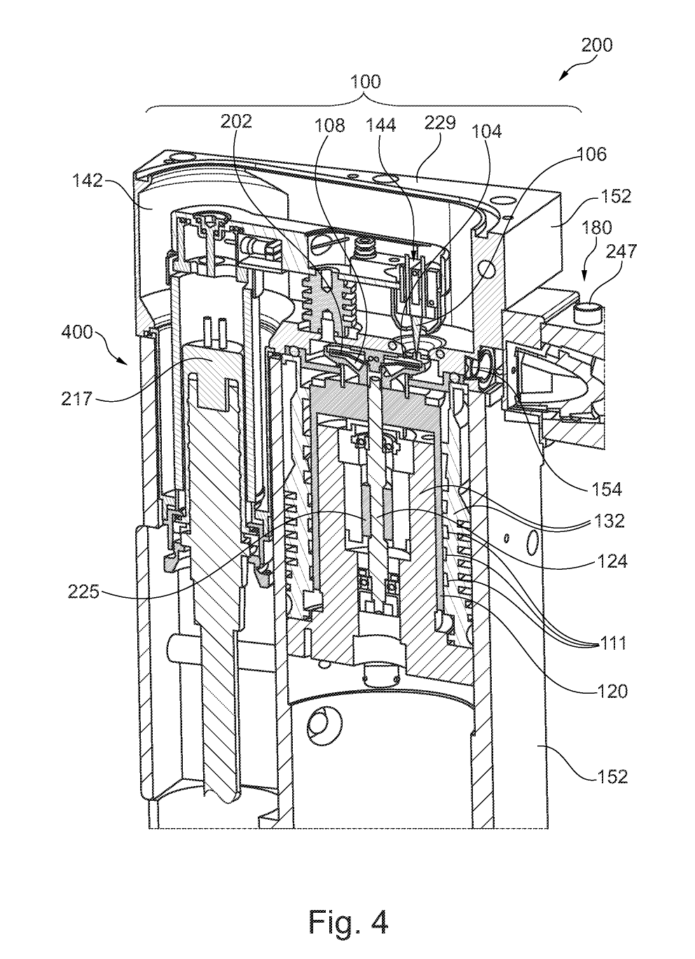

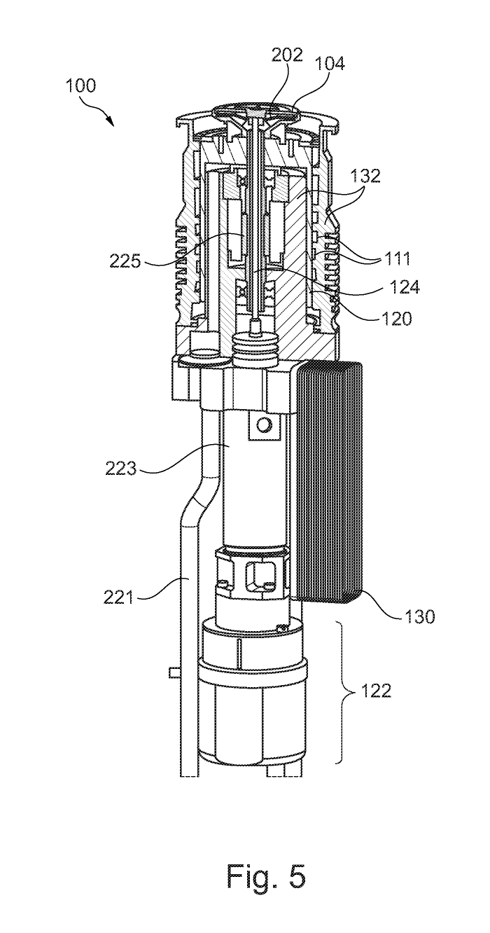

FIG. 4 and FIG. 5 are enlarged views of parts of the X-ray tube 100. FIG. 4 also illustrates a high voltage connector 400 to be connected to a high voltage generator (which is usually located outside of the housing 152.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. An X-ray tube for generating an X-ray beam, the X-ray tube comprising:
a rotatably mounted anode arranged and configured to generate X-rays upon exposure to an electron beam;
a hollow space within the anode;
a cooling unit configured for cooling the anode by fluid circulation within the hollow space;
a vacuum pump arrangement configured for generating a first vacuum within the hollow space and a second vacuum in a space surrounding the anode, wherein the second vacuum relates to a pressure value being lower than a pressure value relating to the first vacuum;
wherein the vacuum pump arrangement comprises a pump arranged for forming a continuous pressure gradient between the first vacuum and the second vacuum.

2. The X-ray tube according to claim 1, wherein the pump is a molecular drag vacuum pump arranged for operating between the first vacuum and the second vacuum.

3. The X-ray tube according to claim 1, wherein the rotatably mounted anode is fixedly coupled to a rotor of the pump so as to be rotatable together with the rotor.

4. The X-ray tube according to claim 1, wherein the cooling unit comprises a cooling fluid pump configured for pumping a cooling fluid through the hollow space.

5. The X-ray tube according to claim 4, comprising at least one of the following features:
the cooling fluid pump comprises one of the group consisting of an oil pump, and a liquid metal pump;
the cooling unit comprises a capillary extending into the hollow space so that the cooling fluid is pumped through the capillary, via an open end of the capillary into the hollow space, and from the hollow space back via a gap between an outer surface of the capillary and a rotor of the pump;
the cooling unit comprises a capillary extending into the hollow space so that the cooling fluid is pumped through the capillary, via an open end of the capillary into the hollow space, and from the hollow space back via a gap between an outer surface of the capillary and a rotor of the pump, wherein the X-ray tube comprises a rotatably mounted cooling fluid distributor arranged between the open end of the capillary and the anode and being configured for distributing the cooling fluid within the gap by a centrifugal force and by pressure applied by the cooling fluid pump;
the cooling unit comprises a capillary extending into the hollow space so that the cooling fluid is pumped through the capillary, via an open end of the capillary into the hollow space, and from the hollow space back via a gap between an outer surface of the capillary and a rotor of the pump, wherein the capillary is fixedly mounted so as to remain stationary, particularly upon rotation of the anode, the rotor and the cooling fluid distributor;
the cooling unit comprises a heat exchanger, particularly a water heat exchanger, configured for removing heat from the circulating cooling fluid.

6. The X-ray tube according to claim 2, wherein the molecular drag vacuum pump comprises a rotatably mounted rotor and a fixedly mounted stator enclosing a seal-free flow path therebetween to evacuate gas molecules in the space surrounding the anode to thereby generate the second vacuum.

7. The X-ray tube according to claim 6, comprising at least one of the following features:
the X-ray tube comprises a flow reducing structure arranged between the rotor and the anode, particularly forming a locally narrowed neck in the flow path, for reducing pressure exchange between the space surrounding the anode and a space between stator and rotor;
the X-ray tube comprises a flow reducing structure arranged between the rotor and the anode, particularly forming a locally narrowed neck in the flow path, for reducing pressure exchange between the space surrounding the anode and a space between stator and rotor, wherein the molecular drag vacuum pump is configured to evacuate, through the flow reducing structure, also gas molecules around the rotatable anode;
the X-ray tube comprises a flow reducing structure arranged between the rotor and the anode, particularly forming a locally narrowed neck in the flow path, for reducing pressure exchange between the space surrounding the anode and a space between stator and rotor, wherein the flow reducing structure is arranged so that a third vacuum or vacuum range within the space between stator and rotor relates to one or more pressure values being larger than or equal to a pressure value relating to the second vacuum.

8. The X-ray tube according to claim 1, further comprising an electron beam generator chamber being at a fourth vacuum and having an electron beam generator configured for generating the electron beam, wherein the fourth vacuum relates to a pressure value being lower the pressure value relating to the second vacuum.

9. The X-ray tube according to claim 8, comprising at least one of the following features:
the pressure value relating to the fourth vacuum is in a range between 10⁻⁶ mbar and 10⁻¹⁰ mbar;
the space surrounding the anode is seal-free, particularly window-free, connected to the electron beam generator chamber;
the X-ray tube comprises a flow reducing structure arranged between the space surrounding the anode and the electron beam generator chamber, particularly forming a locally narrowed neck in the flow path, for reducing pressure exchange between the space surrounding the anode and the electron beam generator chamber;
the X-ray tube comprises a flow reducing structure arranged between the space surrounding the anode and the electron beam generator chamber, particularly forming a locally narrowed neck in the flow path, for reducing pressure exchange between the space surrounding the anode and the electron beam generator chamber, wherein the electron beam generator is arranged for guiding the electron beam from the electron beam generator chamber to the anode via the flow reducing structure.

10. The X-ray tube according to claim 8, wherein the vacuum pump arrangement comprises a high vacuum pump, particularly a turbo molecular vacuum pump, for generating the fourth vacuum.

11. The X-ray tube according to claim 10, wherein the high vacuum pump is configured for operating between the fourth vacuum and another vacuum, particularly the first vacuum provided by the low vacuum pump.

12. The X-ray tube according to claim 1, comprising at least one of the following features:
the pressure value relating to the first vacuum is in a range between 10⁻³ mbar and 20 mbar;
the pressure value relating to the second vacuum is in a range between 10⁻⁴ mbar and 10⁻⁶ mbar;
the vacuum pump arrangement comprises a low vacuum pump, particularly one of the group consisting of a rotary vane pump and a diaphragm pump, for generating the first vacuum;
the X-ray tube comprises a tube housing accommodating at least the anode and the pump;
the X-ray tube comprises a tube housing accommodating at least the anode and the pump, wherein the tube housing has a window being transparent for X-rays and being arranged so that the X-rays are capable of propagating from the anode, via the window into an optic housing having X-ray optics for collecting and focussing X-rays, the optic housing being attachable to the tube housing;
the X-ray tube comprises a tube housing accommodating at least the anode and the pump, wherein the tube housing has a first section accommodating the anode and has a second section accommodating the pump, wherein the first section is made of a material being strongly attenuating or basically intransparent for X-rays, particularly steel, and the second section is made of another material than the first section, particularly a light-weight metal, more particularly Aluminum, even more particularly not necessarily being strongly attenuating for X-rays.

13. An X-ray source, comprising:
an X-ray tube according to claim 1;
an X-ray optic for collecting and focussing X-rays generated in the X-ray tube;
an X-ray beam conditioner for conditioning the X-rays after collecting and focussing them by the X-ray optic.

14. A method of operating an X-ray tube for generating an X-ray beam, the method comprising:
exposing a rotating anode to an electron beam to thereby generate X-rays;
cooling the anode by fluid circulation within a hollow space within the rotating anode;
operating a pump to form a continuous pressure gradient between a first vacuum, provided by another pump, and a second vacuum so that the first vacuum is present within the hollow space and the second vacuum is generated in a space surrounding the anode, wherein the second vacuum relates to a pressure value being lower than a pressure value relating to the first vacuum.
